(19) United States
(12) Patent Application Publication
(10) Pub. No.: US 2006/0092649 A1
(43) Pub. Date: May 4, 2006

(54) Vehicle interior courtesy lamp assembly

(75) Inventor: Stephen A. Bynum, Cookeville, TN (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(73) Assignee: Federal-Mogul World Wide, Inc., Southfield, MI (US)

(21) Appl. No.: 10/978,658

(22) Filed: Nov. 1, 2004

(51) Int. Cl. B60Q 1/26; F21S 8/10; B64D 47/02

(52) U.S. Cl. 362/488; 362/471; 362/545; 362/546

(57) ABSTRACT

A compact lamp assembly for use in interior vehicle application such as reading and courtesy lighting. The lamp assembly includes a housing, a circuit board, and an LED. The housing has a front wall with a concave portion and annular bezel, as well as a side wall and several interior walls. The concave surface includes an off-center opening that is aligned along an axis that forms an oblique angle with respect to the central axis of the housing. The LED is mounted to the circuit board and is positioned in a protective interior space formed behind the opening in the concave surface. When assembled, the LED emits light through the opening such that it exits the lamp assembly at an angle, traveling along the axis of the opening rather than along the central axis of the housing.

### TECHNICAL FIELD

This invention relates generally to lamp assemblies and, more particularly, to lamp assemblies that utilize light emitting diodes (LEDs) to provide courtesy lighting within vehicle interiors.

### BACKGROUND OF THE INVENTION

Lamp assemblies have been used in vehicles to provide various types of illumination. One particular type is courtesy lighting, which is generally provided to either an interior or exterior area when an occupant is entering or exiting the vehicle. For example, courtesy lamps can be mounted on an interior door panel to illuminate the ground underneath an opened door, they can be installed under a seat assembly to illuminate the area in front of the seat, or they can be mounted on a lift-gate to illuminate the surrounding cargo area when the lift gate is open, to name but a few applications. Courtesy lamps can be activated automatically, such as by a door or lift gate sensor, or they can be manually operated, such as by a switch. It is oftentimes desirable to provide a lamp assembly that can direct the emitted light in a particular direction and still be of a simple and relatively compact design.

LEDs are alternative light sources to incandescent bulbs, which have traditionally been used in such lamp assemblies, and can offer certain advantages. For instance, in some applications LEDs last longer than incandescent bulbs, are more compact, and provide a more controllable illumination. Some examples of prior art lamp assemblies utilizing LEDs are disclosed in U.S. Pat. No. 6,595,656 to Yoda, U.S. Pat. No. 4,466,050 to Lockard, and U.S. Pat. No. 4,070,568 to Gala.

### SUMMARY OF THE INVENTION

In accordance with one aspect of the invention, there is provided a lamp assembly for use with a vehicle component that generally includes a housing, a circuit board, and a light emitting diode (LED). The housing has a front wall comprising a concave surface and at least one side wall extending away from the front wall. The concave surface is generally aligned along a first axis normal to the front wall of the housing and includes an opening for allowing light from the LED to exit the housing. The opening is generally aligned along a second axis that is oblique with respect to the first axis. Thus, when assembled to the vehicle, the lamp assembly provides illumination through the opening at an angle relative to the first axis. This can be useful where it is desirable to direct the light, for example, downwardly from the inside surface of a vehicle door panel so that it illuminates the ground when the door is open and/or a footwell within the vehicle when the door is closed.

In accordance with another aspect of the invention, there is provided a lamp assembly having a housing, a circuit board, and an LED, where the housing includes a front wall, a generally cylindrical side wall, and at least one interior wall. Furthermore, the front wall includes an annular bezel and a concave portion having an opening. The interior wall contacts the concave portion and at least partially forms an interior space that is located behind the opening. The LED is electrically coupled to the circuit board and is located generally within the interior space so that it can provide illumination through the opening.

In accordance with yet another aspect of the invention, there is provided a lamp assembly for mounting in an opening in a substantially planar portion of a vehicle interior panel. The lamp assembly includes an LED or other light source and a housing having a front cover that includes an outer bezel having a rear surface that defines a mounting plane such that the rear surface abuts the planar portion of the vehicle interior panel when the housing is inserted into the opening from a front side of the panel. The front cover has a concave portion that is surrounded by the bezel and that extends inwardly of the rear surface into the opening in the panel. The concave portion has a window with the light source being mounted in the housing behind the window such that light from the light source exits the lamp assembly at an angle that is oblique relative to the mounting plane.

### BRIEF DESCRIPTION OF THE DRAWINGS

A preferred exemplary embodiment of the invention will hereinafter be described in conjunction with the appended drawings, wherein like designations denote like elements, and wherein:

FIG. 1 is a front perspective view of a lamp assembly of this invention, showing an angle α between a first axis and a second axis;

FIG. 2 is a top plan view of the lamp assembly of FIG. 1;

FIG. 3 is a cut away view of the lamp assembly of FIG. 1 taken along line 3-3 of FIG. 2, this figure also shows the lamp assembly being installed in a vehicle panel; and

FIG. 4 is a rear perspective view of the lamp assembly of FIG. 1, showing a circuit board press-fit between interior walls and a side wall.

### DETAILED DESCRIPTION OF THE PREFERRED EMBODIMENT

Referring to the figures, there is shown an embodiment of a lamp assembly of the present invention that is used to provide courtesy lighting for an automotive interior. Alternatively, the lamp assembly of this invention could provide other types of illumination, such as that provided by dome or map lights, it could be used to provide exterior lighting, or it could be used on vehicles other than automobiles. For instance, the lamp assembly of this invention could be utilized on vehicles such as recreational vehicles, motor homes, motorcycles, airplanes, trains, boats, etc. Thus, the word “vehicle” is used herein in its broadest sense to encompass all types of vehicles that require some type of illumination, including but not limited to automobiles.

Lamp assembly 10 of the present invention generally includes a housing 12, a circuit board 14, and a light emitting diode (LED) 16. Housing 12 has a somewhat cylindrical and compact shape, and is preferably injection molded from a light impermeable plastic such as a polycarbonate material, a polypropylene material, an acrylonitrile butadiene styrene (ABS) material, or any other appropriate material known to those skilled in the art. Although it is desirable to mold housing 12 into a unitary structure, it could be molded into separate components that are subsequently attached to one another. Once formed, housing 12 is a rigid component that generally includes a front cover 20, a side wall 22, interior walls 24-30, and a first axis 32.

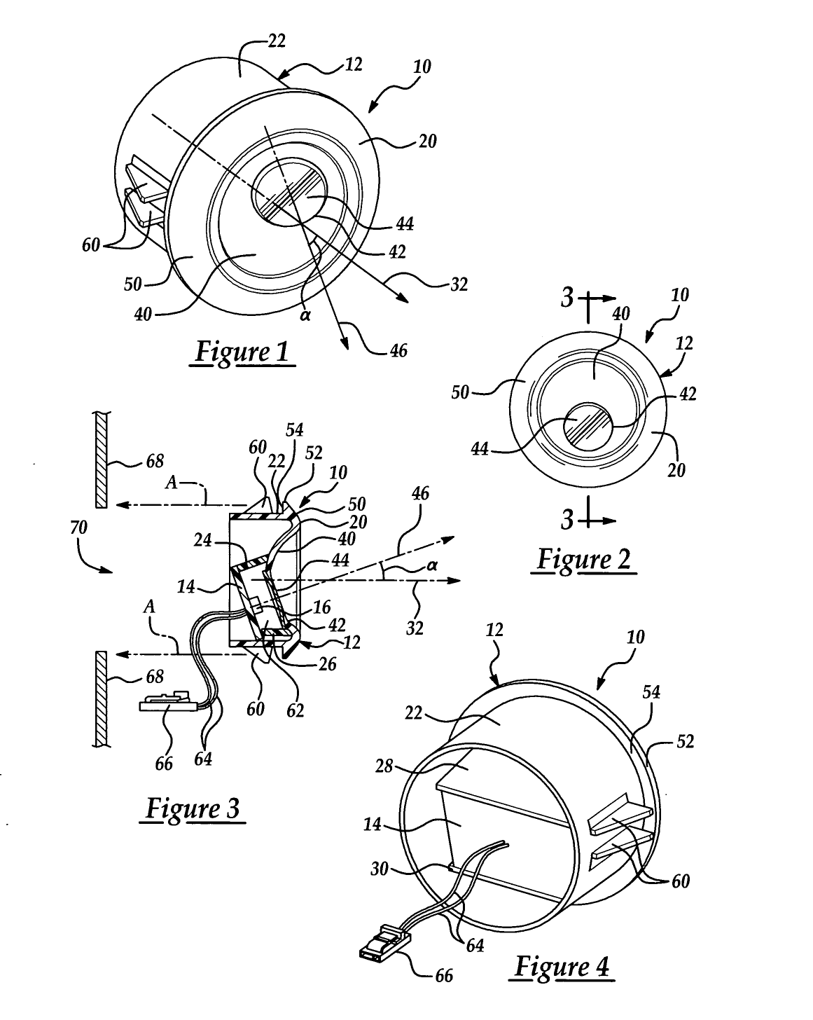

With specific reference to FIGS. 1-3, front cover 20 comprises a single or multi-piece front wall that forms the part of housing 12 that is exposed to a vehicle interior when lamp assembly 10 is installed on a vehicle interior panel or other component. Front wall 20 is generally circular in shape and has an inner concave portion 40 surrounded by an outer annular bezel 50, both of which are coaxially disposed along a first axis 32 which is an imaginary line normal to (in the geometric sense) the front wall 20. This first axis 32 represents the central axis of lamp assembly 10. Concave portion 40 is a generally concave or bowl-shaped surface that includes an opening 42 in its otherwise continuous surface. The opening allows light transmission through the front cover and is preferably in the shape of a circle, however, other shapes such as ovals, rectangles, etc. could alternatively be used. Opening 42 is preferably located at an off-center position, with respect to concave surface 40 and first axis 32, such that it is aligned along a second axis 46 that extends normal to the plane of the opening 42. Second axis 46 preferably forms an oblique angle α with respect to first axis 32, the exact value of which depends on the particular characteristics of the lamp assembly 10 and the specific application for which the assembly is being used, but is generally between 5° and 85°. In the particular embodiment shown here, a window 44 is disposed in opening 42 to close off the opening while allowing light emitted from LED 16 to pass through opening 42 naturally and substantially uninterrupted along second axis 46. If desired, the window 44 can be a lens that is used to redirect or otherwise optically affect the LED light as it passes through the opening.

Annular bezel 50 is a generally ring-shaped component that surrounds concave surface 40 such that the two components are generally coaxially aligned along first axis 32. In fact, the annular bezel begins directly at the concave surface outer periphery. The bezel further extends radially beyond side wall 22 to form a flange 52, which is a continuous ring-shape component with a rear surface 54 as shown in FIGS. 3 and 4. With specific reference to FIG. 3, it is shown that the top surface of annular bezel 50 is somewhat slanted in a backward direction towards the rear of the housing such that flange 52 is tapered towards its outer periphery. When installed, flange 52 acts as a so-called “beauty ring” for the lamp assembly and its rear surface 54 contacts a front surface of the vehicle interior panel to which the assembly is installed. When used with a vehicle panel having a mounting opening in a substantially planar portion of the panel, such as is shown in FIG. 3, the rear surface 54 of the flange 52 defines a mounting plane normal to the first axis 32. This imaginary mounting plane can be used in addition to or in lieu of the first axis 32 as a reference against which the angle of the optical axis of the light emitted by the lamp assembly 10 can be measured. This is useful where the shape of the concave portion does not easily admit of a first axis or center point so that the direction of the emitted light can be determined as it would be seen when in use in its intended vehicle application.

Side wall 22 is preferably a cylindrical component that extends away from and is formed with front wall 20. Turning again to FIGS. 3 and 4, side wall 22 surrounds and protects the interior components of the lamp assembly, including circuit board 14, LED 16, and interior walls 24-30. The side wall axially extends beyond the interior components and ends in a circular opening, which provides access to the rear of housing 12. A pair of mounting clips 60 is disposed on the outer surface of side wall 22 and aid in installation of the assembly to a vehicle component. Even more preferably, two pair of mounting clips 60 are disposed on opposite sides of side wall 22 such that they are separated by approximately 180°. These mounting clips can be implemented as conventional installation devices that are known to those skilled in the art.

Depending on the application, proper alignment of the lamp assembly 10 in the vehicle panel or other component may be necessary due to the directionality of the light emitted from the lamp assembly. This can be done by rotating the housing 12 during mounting to the proper angular position. Alternatively, the housing can be keyed to the opening using the clips 60 or in any other suitable manner.

Interior walls 24, 26, 28 and 30 are located within the lamp assembly and generally form an interior space 62 for accommodating circuit board 14 and LED 16. Each of the interior walls preferably extends from a rear side of concave surface 40 towards the rear of the housing. Collectively, the interior walls form a generally rectangular configuration with walls 24 and 26 opposing one another and walls 28 and 30 also opposing one another. The interior space 62 formed by interior walls 24-30 is positioned such that it is preferably located behind opening 42. As best seen in FIG. 3, interior wall 24 is somewhat slanted with respect to first axis 32 and side wall 22, while wall 26, on the other hand, is generally parallel with the first axis and the side wall. Alternatively, housing 12 could include fewer than or more than the four interior walls shown and discussed herein. In such an embodiment, the circuit board and LED may not be completely surrounded by the interior walls, although they still would be generally surrounded by the other housing components such as the side wall. It is preferable that interior walls 24-30 be integrally formed with the other housing components; however, they could be independently formed and subsequently attached to those components.

Circuit board 14 is located generally within housing 12 and provides LED 16 with power and a base for mounting. The circuit board is sized for press-fitting between one or more of the interior walls 24-30 and/or side wall 22. From an electronics perspective, circuit board 14 can be designed according to one of numerous conventional embodiments known to those skilled in the art, and it can include various types of circuit logic and components. According to a preferred embodiment, circuit board 14 includes a printed circuit for routing power to LED 16 from a pair of connected lead wires 64. Lead wires 64 are coupled to and extend from a rear side of circuit board 14 at one end, and are coupled to an electrical connector 66 at the other end. Preferably, electrical connector 66 is a detachable electrical connection, so that lamp assembly 10 can be easily removed or installed by simply detaching or attaching connector 66 to the vehicle electrical system. Although this configuration is preferred, various other types of electrical connections, including being hard wired, could be used in its place. The circuit board is designed so that LED 16, as well as any sensitive circuit logic, are located on the front side of the circuit board and thus face opening 42, as opposed to facing the open rear end of the assembly. This protects circuit 14 and LED 16 from any exterior contaminants.

LED 16 is located within interior space 62 and is arranged to provide illumination generally along second axis 46. The LED is preferably mounted directly on circuit board 14 so that (i) it is surrounded by interior walls 24-30, (ii) it is located within interior space 62, and (iii) it faces opening 42 such that the optical axis of the LED is coincident with the second axis 46 when the circuit board 14 is mounted in housing 12. Accordingly, when the LED is illuminated, it emits light that passes through the opening and along the second axis. Of course, LED 16 can be one of numerous types of conventional LEDs known to those persons of ordinary skill in the art, including embodiments directed to various types of intensity, color, power consumption, etc. A particular LED is chosen for the particular lighting application in which the lamp assembly will be used.

Assembly of the lamp unit 10 generally involves only three components: housing 12, window/lens 44, and the circuit board assembly, which includes circuit board 14, LED 16, lead wires 64, and electrical connector 66. First, the window/lens 44 is preferably snapped into opening 42, although it can be attached by other techniques known in the art. Second, the circuit board assembly, which is preferably pre-assembled, is press-fitted in between interior walls 28, 30 and against the rear edges of interior walls 24, 26. Depending on the design, the circuit board can also be designed to be press-fit against side wall 22, in which case the side of circuit board 14 that contacts side wall 22 is preferably shaped to complement the shape of the side wall. This way when the circuit board is press-fit into place, it seals the rear end of interior space 62 by contacting either side wall 22 and/or one or more of the interior walls 24-30 all along its periphery. Of course, the order of this process could vary, as the circuit board could be installed first followed by the insertion of the lens.

Lamp assembly 10 is installed from a front side of a vehicle panel or component 68 such that it is inserted through an opening 70 as shown in FIG. 3. The vehicle opening is preferably circular to complement the shape of side wall 22, but could vary to meet the individual needs of the particular application. Opening 70 preferably has an interior diameter that is slightly larger than the exterior diameter of side wall 22, but is smaller than the exterior diameter of flange 52. Thus, the lamp assembly is inserted into opening 70 along direction A until a rear surface of flange 52 contacts a front surface of the vehicle component 68. The mounting clips 60 and/or panel 68 are somewhat resilient and will flex inward to allow the interior surface of opening 70 to slide past the clips 60 when the assembly is being installed. The lamp assembly is inserted until the rear surface 54 of flange 52 contacts the surface of the vehicle panel 68. In this position, the thickness of component 68 is trapped between mounting clips 60 and the rear side of flange 52, thus firmly maintaining lamp assembly 10 in place. When viewed from the front of panel 68, flange 52 is a beauty ring that disguises opening 70 once the lamp assembly is installed.

It will thus be apparent that there has been provided in accordance with the present invention an LED lamp assembly that achieves the aims and advantages specified herein. It will of course be understood that the foregoing description is of preferred exemplary embodiments of the invention and that the invention is not limited to the specific embodiments shown. For example, rather than angling the LED optically along the second axis 46, refractive and/or reflective optics could be used to re-direct the light emitted from the LED. Also, alternative methods other than press-fitting can be used to secure lens 44 and circuit board 14 in place, including gluing, welding, or other techniques. Furthermore, one or more of the interior walls 24-30 could be omitted such that interior space 62 is not completely confined by the interior walls. Also, bezel designs other than that shown can be used, whether functionally different, aesthetically different, or both. Various changes and modifications will become apparent to those skilled in the art and all such variations and modifications are intended to come within the scope of the appended claims.

I claim:

1. A lamp assembly for use with a vehicle component, comprising:
a housing having a front wall and at least one side wall that extends away from said front wall, said front wall including a generally concave surface with an opening for allowing light transmission, said concave surface being generally aligned along a first axis and said opening being generally aligned along a second axis that is oblique with respect to said first axis;
a circuit board mounted to said housing; and
a light emitting diode (LED) electrically coupled to said circuit board, wherein said LED is aligned to provide illumination through said opening and generally along said second axis.

2. The lamp assembly of claim 1, wherein said front wall further includes an annular bezel generally surrounding said concave surface.

3. The lamp assembly of claim 2, wherein said annular bezel extends beyond said side wall to form a flange having a rear surface that contacts a front surface of the vehicle component when said lamp assembly is installed.

4. The lamp assembly of claim 1, wherein said housing further includes at least one interior wall connected to said concave surface to form an interior space behind said opening.

5. The lamp assembly of claim 4, wherein said LED is mounted to said circuit board and wherein said circuit board is press-fit generally within said interior space so that said LED can provide illumination through said opening.

6. The lamp assembly of claim 1, wherein said assembly further includes an electrical connector coupled to said circuit board to provide said assembly with a detachable electrical connection.

7. The lamp assembly of claim 1, wherein said side wall includes at least one mounting clip located on its outer surface to aid in installation of said assembly to the vehicle component.

8. The lamp assembly of claim 1, wherein said assembly further includes a lens disposed in said opening.

9. A lamp assembly for use with a vehicle component, comprising:
a housing having a front wall, a generally cylindrical side wall extending from said front wall, and at least one interior wall;
said front wall including a concave portion with an opening for allowing light transmission and an annular bezel that surrounds said concave portion;
said at least one interior wall being in contact with said concave portion and at least partially forming an interior space located behind said opening;
a circuit board located generally within said housing; and
an LED electrically coupled to said circuit board and located generally within said interior space so that said LED can provide illumination through said opening.

10. The lamp assembly of claim 9, wherein said concave portion and said annular bezel are generally disposed coaxially along a first axis, and wherein light from said LED exits said lamp assembly generally along a second axis that is oblique relative to said first axis.

11. The lamp assembly of claim 10, wherein said opening is offset from said first axis.

12. The lamp assembly of claim 9, wherein said annular bezel extends beyond said side wall to form a flange having a rear surface that contacts a front surface of the vehicle component when said lamp assembly is mounted within an opening in said vehicle component.

13. The lamp assembly of claim 9, wherein said LED is mounted to said circuit board and wherein said circuit board is press-fit generally within said interior space so that said LED can provide illumination through said opening.

14. The lamp assembly of claim 9, wherein said assembly further includes an electrical connector coupled to said circuit board to provide said assembly with a detachable electrical connection.

15. The lamp assembly of claim 9, wherein said side wall includes at least one mounting clip located on its outer surface to aid in installation of said assembly to the vehicle component.

16. The lamp assembly of claim 10, wherein said assembly further includes a lens disposed in said opening.

17. A lamp assembly for mounting in an opening in a substantially planar portion of a vehicle interior panel, comprising:
a light source; and
a housing having a front cover that includes an outer bezel having a rear surface that defines a mounting plane such that said rear surface abuts the substantially planar portion of the vehicle interior panel when said housing is inserted into the opening from a front side of the panel, said front cover having a concave portion surrounded by said bezel and extending inwardly of said rear surface into the opening when said housing is inserted into the opening with said rear surface abutting the panel, said concave portion having a window with said light source being mounted in said housing behind said window such that light from said light source exits said lamp assembly at an angle that is oblique relative to said mounting plane.

18. The lamp assembly of claim 17, wherein said bezel comprises an annular bezel having an outer flange that includes said rear surface, and wherein said concave portion extends inwardly from said annular bezel.

19. The lamp assembly of claim 17, wherein said concave portion is centered on an axis that extends normal to said mounting plane, and wherein said window is offset from said axis such that light from said light source exits said window along a second axis that is angled relative to said first axis.

20. The lamp assembly of claim 17, further comprising a circuit board located within said housing behind said concave portion, wherein said light source comprises an LED mounted to said circuit board behind said window.
